(19) United States
(12) Patent Application Publication
(10) Pub. No.: US 2005/0006501 A1
(43) Pub. Date: Jan. 13, 2005

(54) Fluid control in jets

(76) Inventors: Derek John Englefield, Auckland (NZ); Roy Victor Bladen, Albany (NZ)

Correspondence Address: YOUNG & THOMPSON, 745 SOUTH 23RD STREET, 2ND FLOOR, ARLINGTON, VA, 22202, US

(21) Appl. No.: 10/462,757

(22) Filed: Jun. 17, 2003

(30) Foreign Application Priority Data
Jun. 11, 2003 (NZ) 526397

(51) Int. Cl. B05B 1/30

(52) U.S. Cl. 239/581.1; 239/569

(57) ABSTRACT

The present invention is directed to apparatus for controlling the flow of a fluid, finding particular use in spray jet assemblies such as may be used in shower cabinets and temples. Flow control, in preferred embodiments, is through rotational adjustment of a closure arrangement which progressively obscures a port through which fluid flows, the preferred arrangement being an annular sleeve with profiled body wall which, upon rotation, progressively obscures a radial port in a central body portion about which it is located.

### TECHNICAL FIELD OF INVENTION

The present invention is directed to controlling the flow of a fluid. Typical applications are in conjunction with shower head and jet assemblies such as may find use in shower cabinets and temples. Control in preferred embodiments is through rotational adjustment by the user, and preferably allowing a reduction in flow rate by the user.

### BACKGROUND ART

The present invention has been developed with the problems associated with body and shower jets, such as used in shower cabinets, in mind. However it should be envisaged that the techniques described herein may be applied to other applications where some form of fluid control may be required. For simplicity of description however, and to also demonstrate the advantages of a present invention when applied to shower and body jets, the description will largely focus on body jets for use in shower cabinets and the like, unless otherwise stated.

The term “shower cabinet” where used will be used in a broad sense. It will encompass, in general, any area whether fully or partially enclosed or otherwise where a spray of fluid is to be directed onto a person or article. This may include typical shower enclosures, shower temples (which tend to be characterised by multiple jets from different angles and not necessarily being fully enclosed), through to more open arrangements such as may be found in sports changing rooms.

A preferred embodiment of the invention includes the method of fluid control within a body jet for use in a shower cabinet. The term “body jet” will be used in a broad sense as including any device or arrangement able to connect to a fluid supply and produce a body of water in a jet or spray pattern. Within the industry body jets are commonly used to describe spray mechanisms which are typically positioned and oriented to be directed against the body of a user of the shower cabinet. This may be in a substantially horizontal or vertically directed orientation, As previously indicated, for the purposes of this specification the term, unless specifically otherwise stated, shall include any device or arrangement for producing a body of water emitted in a spray or jet like pattern.

There are a number of considerations and factors to be taken into account in the design of body jets (used in the broadest sense of the term) in the art. While traditional shower cabinets may only have one shower head or jet assembly, there is a tendency in more expensive shower cabinets to provide a plurality of such body jets. These may be provided in differing arrangements though typically are provided at varying heights so as to be directed towards a user standing substantially centrally within the shower cabinet. However a major consideration in the use of multiple jets is the volume of water which is consumed. From a practical point of view, the provision of too many jets may exceed the supply capabilities of normally available water supplies. Standard domestic supply pressures and flow rates can vary substantially in different parts of the world and also according to the nature of the supply (e.g. town reservoir or on-site storage facilities). However another consideration is regulatory restrictions, particularly in areas where water may be in short supply.

The United States is one country where there are regulations governing the maximum throughput through a single jet assembly. Accordingly it is desirable to have some control over the flow rate through a body jet and in the past this has been achieved in a number of different ways, For instance, maximum flow (for a typical nominal pressure) can be regulated by limiting the size of internal apertures through which the water must flow, and/or through the provision of some form of flow control mechanism. Flow regulators which are positioned in line are another option.

In addition, there is some advantage in providing some form of variable control over flow characteristics from individual body jets. This can allow a multiple jet system within a shower cabinet to be find tuned and balanced, and/or set up to cater for individual user preferences. In the art a number of attempts have been made to control flow rates though these have met with limited success.

For instance, one body jet on the market has a water inlet from the side and has centrally positioned valve to control flow through the body jet. The central valve is based on a hollow cylinder in which an internal seal can be screwed down to obscure some apertures through which the water must flow. However, in practise, this affords relatively poor flow control and the overall design has a relatively high water requirement i.e. requires a high flow rate.

In another commercial design, an axially positioned part of the body jet can be pushed in or out to close off the flow of water. However this does not provide any flow control and only operates in an on/off manner.

In another commercially available mini jet there are provided two substantially planar discs co-extensive with each other. A series of several holes are provided in one of the planar surfaces while a curved slot is provided in the other. Rotating the planar surfaces relative to one another progressively exposes and/or obscures the holes so as to control fluid flow. In many ways the arrangement is similar to ceramic disc arrangements in taps and an effective thirty percent variation in water flow is claimed. However in practise, trials by the applicant have indicated that the achievable variation in flow is closer to five percent under normal operating conditions. This highlights some of the inherent problems of body jets and considerations to be taken into account in the design of flow control mechanisms.

In the majority of body jets an axial water connection is made to the supply line i.e. the inlet conduit to which the supply line is attached is substantially parallel or coaxial with the main axis of the body jet. Typically the spray or jets of water which are expelled from tie body jet are also substantially parallel to this axis or at an acute angle thereto. However, normal operating supply pressures spend a considerable amount of their force against internal surfaces within the body jet. In practise up to around ninety percent of the supply pressure may be dissipated against internal componentry before it leaves the body jet. In an axial system having two planar disc like surfaces substantially perpendicular to this axis, the majority of inlet pressure may be expended against one of these surfaces to separate them. However, such mechanisms can only effectively operate if the two surfaces are maintained and substantially tight contact against each other. One is therefore constantly battling against the supply pressure and the relatively poor flow control of the aforedescribed embodiment (where only live percent variation is typically observed in trials) is thought to be attributed to water leakage between the two surfaces of the discs.

One possible solution is to have the inlet supply connection porting from the side of the device though this is not always convenient and the majority of available body jet are designed to have axial inlet supply connections.

There is therefore a need for a fluid control mechanism, suitable for use in body jets and the like, which can provide for variable adjustment of the flow through the body jet. In practise, where variable control has been provided in a body jet, the control is quite coarse making it very difficult to progressively and relatively evenly vary flow rates. There is therefore a need and desire for a fluid control mechanism suitable for use in body jets which will allow for fine adjustment and control over flow rates through the body jet.

It is therefore an object of the present invention to consider and address these problems. In a broad sense one object of the present invention is to provide an alternative flow control mechanism suitable for use in body jets for shower cabinets, though which may possibly also find use in other applications. At the very least it is an object of the present invention to provide the public with an useful alternative.

According to one aspect of the present invention there is provided a fluid flow controlling mechanism which includes a peripheral port in the curved face of a central body portion, the mechanism including a closure arrangement movable relative to said port to progressively obscure the port's opening.

According to another aspect of the present invention there is provided a fluid flow controlling mechanism, substantially as described above, in which said relative movement of the closure clement with respect to the port is a rotational movement.

According to another aspect of the present invention there is provided a fluid flow controlling mechanism, substantially as described above, in which the closure element consists of an annular or sleeve-like arrangement disposed about the central element and able to rotate at least partially thereabout.

According to another aspect of the present invention there is provided a fluid flow controlling mechanism, substantially as described above, in which the closure element during permitted rotational movement actually follows a substantially helical path relative to the port.

According to a further aspect of the present invention there is provided a fluid flow controlling mechanism which includes a fluid conducting portion which in turn includes a porting portion having rotational symmetry;

there being present in the porting portion at least one outwardly venting port through which fluid may flow;

there being disposed about at least part of the outer surface of the porting portion a closure arrangement of one or more elements which bear against the curved outer surface of the porting portion;

and wherein the closure arrangement is permitted to rotate at least partly about the porting portion and wherein the configuration of the closure assembly is such that during permitted rotation of the assembly the venting port is progressively eclipsed thereby altering the effective opening of the port.

According to another aspect of the present invention there is provided a fluid flow controlling mechanism, substantially as described above, in which the closure arrangement includes a ramped and/or stepped portion movable over the port's opening and which progressively alters the available opening of the port as the closure arrangement is rotated with respect to the port containing element.

According to another aspect of the present invention there is provided a fluid flow controlling mechanism, substantially as described above, in which there is present in the fluid controlling mechanism an arrangement which increases the relative height of a closure arrangement relative to the port's opening during rotation of the closure element, and such that a fixed point on the closure arrangement may be seen to approximate a helical or stepped helical path during relative rotation of the closure element about that portion in which the port is present.

According to another aspect of the present invention there is provided a fluid flow controlling mechanism, substantially as described above, in which relative rotation of said closure element is substantially about a rotational axis of symmetry of the portion including the port.

According to another aspect of the present invention there is provided a fluid flow controlling mechanism, substantially as described above, in which the portion of the mechanism in which said port is present includes a body portion with a further port for connection of fluid flowing in a substantially axial direction, and wherein a said port vents fluid directed substantially radially and/or tangentially in direction.

According to another aspect of the present invention there is provided a fluid flow controlling mechanism, substantially as described above, in which the volume or fluid can be varied by at least 30% relative to maximum flow rate.

According to another aspect of the present invention there is provided a fluid flow controlling mechanism, substantially as described above, in which the volume of fluid can be varied by at least 50% relative to maximum flow rate.

According to another aspect of the present invention there is provided a fluid flow controlling mechanism, substantially as described above, in which the volume of fluid cal be varied from substantially no flow through to maximum flow rate.

According to another aspect of the present invention there is provided a fluid flow controlling mechanism, substantially as described above, in which the permitted rotation of the closure arrangement is at least substantially 90 degrees.

According to another aspect of the present invention there is provided a fluid flow controlling mechanism, substantially as described above, in which the permitted rotation of the closure arrangement is at least substantially 180 degrees.

According to another aspect of the present invention there is provided a fluid flow controlling mechanism, substantially as described above, in which the permitted rotation of the closure arrangement is at 270±45 degrees.

According to another aspect of the present invention there is provided a fluid flow controlling mechanism, substantially as described above, in which the permitted rotation of the closure arrangement is in excess of 360 degrees.

According to another aspect of the present invention there is provided a fluid flow controlling mechanism, substantially as described above, in which on average a rotation of the closure arrangement of at least 15 degrees is required for an alteration in fluid flow of 10%.

According to another aspect of the present invention there is provided a fluid flow controlling mechanism, substantially as described above, in which on average a rotation of the closure arrangement of 45±15 degrees is required for an alteration in fluid flow of 10%.

According to another aspect of the present invention there is provided a fluid flow controlling mechanism, substantially as described above, in which there is a substantially linear relationship between relative rotation of the closure arrangement and the alteration in fluid flow.

According to another aspect of the present invention there is provided a fluid flow controlling mechanism, substantially as described above, in which the port's opening is 3±1 mm diameter or the equivalent cross-section area for non-circular ports.

According to another aspect of the present invention there is provided a fluid flow controlling mechanism, substantially as described above, in which the maximum flow is less than 9.4 liters/minute at standard household domestic water supply pressures.

According to another aspect of the present invention there is provided a fluid flow controlling mechanism, substantially as described above, in which the maximum flow is in the range 3 through 5 litres/minute at standard household domestic water supply pressures.

According to another aspect of the present invention there is provided a fluid flow controlling mechanism, substantially as described above, in which the fluid flow controlling mechanism is present in a spray jet assembly.

According to a further aspect of the present invention there is provided a spray jet assembly including an inlet for connection to a fluid supply, a nozzle arrangement allowing for the expulsion of fluid in a spray pattern, and which includes a fluid flow controlling mechanism substantially as described above.

According to another aspect of the present invention there is provided a spray jet assembly, substantially as described above, in which the nozzle arrangement includes a plurality of fine apertures.

According to another aspect of the present invention there is provided a spray jet assembly, substantially as described above, in which the fluid is water.

According to another aspect of the present invention there is provided a spray jet assembly, substantially as described above, which is intended for use in a shower or cleansing cabinet, in a wet area or enclosure, tiled area, or the like.

According to another aspect of the present invention there is provided a spray jet assembly, substantially as described above, in which the spray jet assembly is intended as a body jet in a shower temple, cabinet or the like.

According to another aspect of the present invention there is provided a spray jet assembly, substantially as described above, in which the inlet for the fluid supply allows for substantially axial fluid flow.

According to another aspect of the present invention there is provided a spray jet assembly, substantially as described above, in which water is expulsed from the assembly in substantially an axial direction.

According to another aspect of the present invention there is provided a spray jet assembly, substantially as described above, in which the closure arrangement of the fluid flow controlling mechanism more rapidly cuts off water flow past a certain lower threshold point to prevent dribbling from the nozzle arrangement at low flow rates.

The arrangement which provides the fluid control according to present invention typically consists of a lateral (as opposed to axial) port which may be eclipsed progressively by another component. The use of a laterally directed port substantially perpendicular to the nominal primary axis helps avoid problems associated with internal pressure forcing components apart. This represented a difficulty, in hindsight, for designs where there were components which could be axially separated from each other due to working fluid pressures. The change in direction of the water flow at least partially addresses this problem.

Secondly, in preferred embodiments the closure arrangement which obscures or eclipses a port is generally an angular ring which fits about a substantially central body portion. In such designs it is not possible for the components to be easily displaced from each other due to working fluid pressures except by any inbuilt tolerances or deformation of the materials of construction themselves, Accordingly, preferred embodiments of the present invention address some of the shortcomings noted in the available prior art designs.

A number of other features and factors have also been considered in the development of the present invention. One consideration is the desire for rotational flow control. In most instances internal working pressures cannot act upon a rotational arrangement to alter a setting which has been made. This is not true of sliding linear arrangements, particularly those where axially directed sliding occurs, as normal fluid operating pressures acting against axially moving components may result in unwanted alteration of adjusted settings.

Another consideration is the ability for relatively fine control such as may be accompanied by rotation about a reasonable or significant angle to effect a change in flow rate. For most body jets, for which a fluid flow controlling mechanism is to be used, any non-rotational control movement (such as linear sliding) will be relatively limited in permissible length and thus not particularly suited for fine control over flow.

Accordingly most flow controlling mechanisms according to the present invention will include a body portion (which may consist of one or more components) which is generally positioned relatively centrally with respect to the flow controlling mechanism. Typically this body portion will have rotational symmetry about at least part oft and preferably all of, its circumference in the region of the ports i.e. the porting portion.

Only one port may be provided in this (porting) portion, though multiple ports may also be provided as a variation.

Typically the port will vent to an outer surface of this central body portion. Typically fluid flow through this port will be substantially radial and/or tangential (or somewhere in between) when the mechanism is viewed along the axis (of rotational symmetry).

Working in conjunction with this body portion is a closure arrangement which may comprise one or more components. In its simplest form the closure arrangement is an annular arrangement able to fit about and rotate at least partially around the port in portion of the central body. The closure arrangement should be configured such that it can progressively eclipse or obscure the provided ports as a consequence of rotation. This may be simply provided by a ramp like portion on the annular arrangement. This ramp can then progressively close or open the port(s) to the outside depending upon the direction of rotation.

The configuration of the ramp can also be altered to change the characteristics of flow in response to rotation. For instance these may be altered to allow substantially linear, exponential, or irregular flow alteration in response to a constant rotation. This may be used, for example, to allow finer control around some particular degrees of opening than others. One such example is rapid close off once the effective opening size of the port drops below a particular threshold. The reason for providing this type of function is to prevent the user selecting flow rates at low levels where fluid is likely to dribble down and across the face of nozzles rather than being expelled in a spray or jet like manner. As can he appreciated there is some flexibility for the user to adopt a wide range of variations thereby affecting the design and operation of the final embodiment which may be constructed.

Where multiple ports are provided on the substantially central body portion, separate ramps for other features may be provided on the closure arrangement for each port. Another arrangement is for a single ramp to progressively eclipse multiple ports.

Typically the central body portion consists of one or more components which allows for connection to a fluid supply and preferably in an substantially axial direction. The main central body portion will then be configured to conduct or convey fluid to the previously mentioned ports. Typically by this stage the fluid will then flow laterally away from the axis depending upon whether or not the ports are closed by the closure arrangement.

In a body jet the central body portion and closure arrangement of the flow controlling mechanism are typically contained in other body components which house tile mechanism. These other components will also help contain and direct the flow of water which vents from the port, and direct these to and through nozzles so that sprays or jets of water are produced as the fluid leaves the body jet apparatus. Typically a plurality of apertures are provided in a head portion for when the body jet apparatus is to be used in a shower cabinet or the like. One or more components for housing may also be connected to the closure arrangement allowing a user to readily alter flow by rotation.

Parameters may vary according to user preferences. However, it is considered that fluid flow controlling mechanisms are likely to be most useful when the flow of fluid passing therethrough can be varied by at least thirty percent relative to the maximum flow rate. Adjustments less than this (i.e. reductions of less than thirty percent of maximum flow rate) can also be considered though typically it may be impractical and uneconomic to do so. In preferred embodiments the volume of fluid can be varied by at least fifty percent relative to the maximum flow rate while in other embodiments, flow rate can be varied from substantially zero flow through to maximum flow. This is ideally a progressive flow change though stepped changes in flow can also be provided for by suitable combinations of port and closure arrangement configuration and design.

Rotation can be continuous and unlimited though typically (in preferred embodiments) rotation with the closure arrangement is limited by stops. Frictional resistance, biasing, and detenting may be employed so the closure arrangement preferentially sits, rests or attains particular positions. Techniques used in rotary switches may be employed.

To provide fine control, the closure arrangement should ideally be allowed to rotate through a reasonable portion of a full circle. It is envisaged that at least 90 degrees rotation should be permitted though this should ideally be for situations where the fluid flow is varied by lesser amounts (e.g. around 30-50%)—this is a guideline only. Preferably the rotation is at least 180 degrees, particularly where from maximum to zero flow is permitted. In a preferred embodiment the permitted rotation for closure arrangement is 270±45 degrees which provides for relatively good control in a relatively accurate manner. As a guideline, there should be (on average) a rotation of the closure arrangement of at least 15 degrees for every alteration fluid flow of 10 percent though a rotation or 45±15 degrees is more preferable for the same alteration in fluid flowing in practise, and a rotation of 30±15 degrees is likely to be the norm in the preferred embodiment.

Variations and modifications may be provided on various embodiments of the present invention. For instance, different nozzle arrangements may be provided to allow for different spray/or jet patterns and characteristics. Rotating internal elements may be provided to produce a pulse effect emanating from the provided nozzles.

Materials of construction can vary with typical materials used in the construction of plumbing items and shower equipment being candidates for use.

Other features in componentry allowing body jets to readily installed in shower cabinets or other supporting structures may also be provided or catered for in the design of the components—typically the housing. Other principles common in the construction and design of such plumbing items may also relied upon where appropriate, such as to allow connection of a flow controlling mechanism and/or body jet to an existing supply of fluid (e.g. domestic water supply).

Typical uses of body jets will be for shower cabinets for washing people or other items (e.g. vehicles, parts and components etc) though other fluids than water may also be used in varying applications. The flow controlling mechanism may be suitable for use in the control of other fluids such as gases though these typically represent offshoots from the typically intended design application of present invention and the problems which it addresses.

### DESCRIPTION OF DRAWINGS

Further aspects and advantages of the invention will be described by way of a example with reference to the following drawings in which:

FIG. 1 is a front elevated perspective view of a preferred embodiment of a flow control mechanism in exploded form,

FIG. 2 the embodiment of FIG. 1 with the components fitted together,

FIG. 3 is a front perspective view from a lowered view point of the embodiment of FIG. 1 also in exploded form,

FIG. 4a-c are cross-sectional diagrammatic views of a preferred embodiment of a body jet illustrating the closure arrangement in varying degrees of closure.

### BEST METHODS OF PERFORMING INVENTION

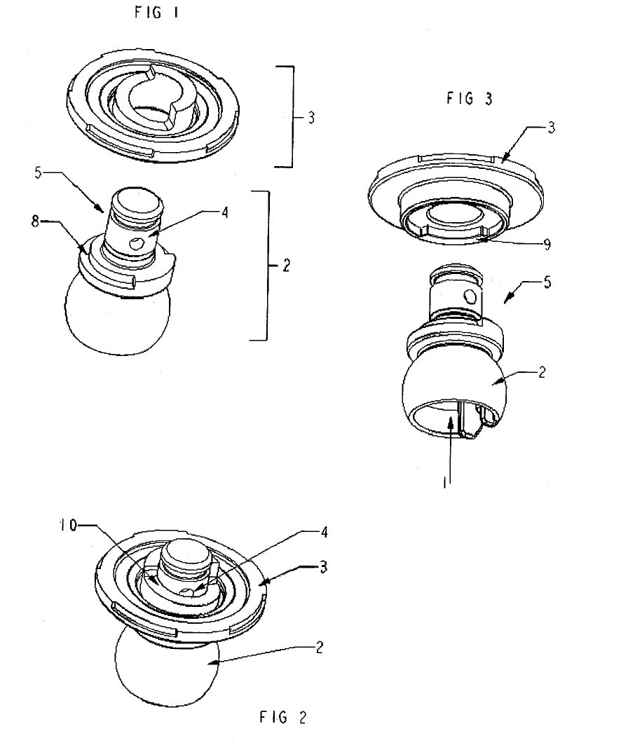

FIG. 1 illustrates a preferred embodiment of a flow controlling mechanism. This mechanism generally consists of a central body portion (2) which co-operates with a closure arrangement (3). The central body portion is substantially hollow as can be more clearly seen in FIG. 3 with a fluid supply being connected at and fluid travelling in a general direction of arrow 1.

The central body portion conducts water (2) out toward the venting port (4) which is present in a curved outer face of a substantially cylindrical top body portion, generally indicated by arrow 5. Also visible in FIGS. 1-3 as part of this top body portion (5) are a number peripheral grooves for accepting seals and/or providing bearing surfaces.

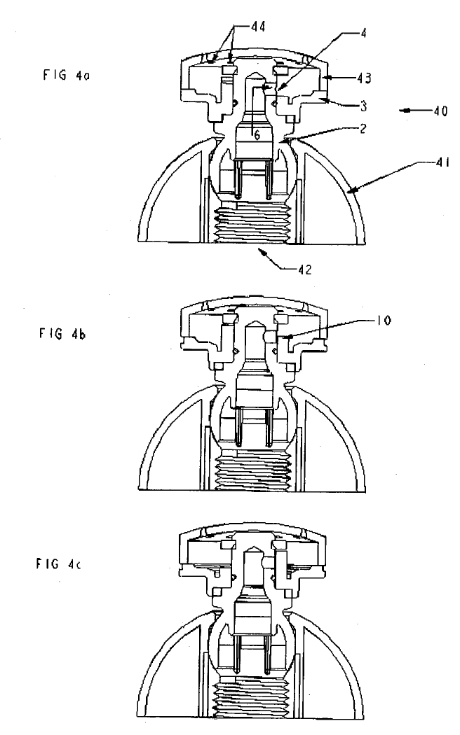

The particular arrangement of the embodiment of FIGS. 1-3 is intended for use in a body jet, a preferred embodiment of which is illustrated in FIG. 4. FIG. 4 also more clearly indicates the internal path (5) which leads fluid from the inlet (3) to port (4).

Referring again to FIG. 1 an annular flange arrangement with a stepped recess (8) co-operates with a similar stepped portion (9) on the under side of closure arrangement (3) (see FIG. 3) so as to limit the rotation of the closure arrangement (3) when the components are assembled such as illustrated in FIG. 2,

The closure arrangement (3) is a substantially annular type component or assembly which fits about the top portion (5) of the central body portion (2). Present on this closure arrangement is a ramped portion generally indicated by arrow 10 which is positioned to interact with the opening of port (4). Depending on the rotational position of closure arrangement (3), this ramped portion (10) can eclipse or obscure the port (4) by varying degrees. This relationship is clearly seen in FIG. 2 where the closure arrangement (3) has been rotated to a position where the opening of port (4) is obscured by approximately fifty percent. As can be appreciated, rotating the annular closure device (3) either clockwise or counter-clockwise from the position shown in FIG. 2 can progressively close and/or open the opening of port (4) (depending upon the direction of the rotation).

FIG. 4 is a series of diagrams illustrating a body jet, generally indicated by arrow 40, The flow controlling mechanism of FIGS. 1-3 has been adopted and the closure portion (3) and central body portion (2) have been identified. The internal conduits illustrate the flow of fluid (6) in the preferred direction and, as can be seen, fluid will enter substantially axially into the body jet assembly (40) before being diverted at right angles to port substantially laterally with respect to the longitudinal axis. This arrangement serves to help dissipate some of the pressure of the fluid supply which may act directly against a closure device for blocking off a port. Similarly, the annular arrangement of the closure device also resists separation of the ramp portion (10)—which blocks the port (4)—from the port opening itself. The potentially realisable advantage is consistent and predictable flow control regardless of inlet supply pressure. It should be appreciated however that flow rate will vary according to inlet pressure for a particular closure position through what is avoided in this type of design are the elimination of additional flow affecting factors such as separation of interacting components from each other due to internal pressure, as is the case in some of the available mechanisms on the market at the present time.

Present also in the body jet of FIG. 4 is a body portion (spray jet assembly) (41) which serves to house and hold the components as well as being aesthetically pleasing. A threaded connector (42) is also provided for the connection of an inlet supply of fluid. A head portion (43) with a plurality of fine apertures (44) is provided to allow fluid to be expelled in a desired spray or jet pattern.

A series of drawings of FIGS. 4a-c illustrate the closure arrangement (3) in different positions such that the ramp in portion (10) obscures the port (4) by varying amounts.

For instance in FIG. 4a the port (4) is approximately two thirds open while in FIG. 4b it is approximately two thirds closed. FIG. 4c illustrates the port (4) completely closed.

In the illustrated embodiment it is possible to go from zero flow through to maximum flow by rotation of the closure arrangement (3) about an angle of approximately 270 degrees. The port aperture is approximately three millimetres though this can be varied to meet user requirements. Materials of construction arc metals and/or plastics materials such as commonly used in plumbing and in the manufacture of componentry of this type.

Aspects of the present invention have been described by way of example only and it is envisaged that modifications and additions may be made thereto without departing from the spirit or scope thereof.

This should also be appreciated that the word “comprised” as used herein is meant to be used in the broadest sense such as “including associated listed items but optionally also including other non-listed items”.

It should also be appreciated that the background art description represents the view or the applicant and/or inventors and typically reflects their views, considerations, and understandings during the developmental stages of the invention. It should not necessarily be regarded as a true, accurate or fully comprehensive statement of the state of the art or prior art knowledge at the time.

1. A fluid flow controlling mechanism which includes a peripheral port in the curved face of a central body portion, the mechanism including a closure arrangement movable relative to said port to progressively obscure the port's opening.

2. A fluid flow controlling mechanism, as claimed in claim 1, in which said relative movement of the closure element with respect to the port is a rotational movement.

3. A fluid flow controlling mechanism, as claimed in claim 1, in which the closure element consists of an annular or sleeve-like arrangement disposed about the central element and able to rotate at least partially thereabout.

4. A fluid flow controlling mechanism, as claimed in claim 1, in which the closure element during permitted rotational movement actually follows a substantially helical path relative to the port.

5. A fluid flow controlling mechanism, as claimed in claim 1, which includes a fluid conducting portion which in turn includes a porting portion having rotational symmetry;
there being present in the porting portion at least one outwardly venting port through which fluid may flow;
there being disposed about at least part of the outer surface of the porting portion a closure arrangement of one or more elements which bear against the curved outer surface of the porting portion;
and wherein the closure arrangement is permitted to rotate at least partly about the porting portion and wherein the configuration of the closure assembly is such that during permitted rotation of the assembly the venting port is progressively eclipsed thereby altering the effective opening of the port.

6. A fluid flow controlling mechanism, as claimed in claim 5, in which the closure arrangement includes a ramped and/or stepped portion movable over the port's opening and which progressively alters the available opening of the port as the closure arrangement is rotated with respect to the port containing element.

7. A fluid flow controlling mechanism, as claimed in claim 5, in which there is present in the fluid controlling mechanism an arrangement which increases die relative height of a closure arrangement relative to the port's opening during rotation of the closure element, and such that a fixed point on the closure arrangement may be seen to approximate a helical or stepped helical path during relative rotation of the closure element about that portion in which the port is present.

8. A fluid flow controlling mechanism, as claimed in claim 5, in which the portion of the mechanism in which said port is present includes a body portion with a further port for connection of fluid flowing in a substantially axial direction, and wherein a said port vents fluid directed substantially radially and/or tangentially in direction,

9. A fluid flow controlling mechanism, as claimed in claim 1, in which the volume of fluid can be varied from substantially no flow through to maximum flow rate.

10. A fluid flow controlling mechanism, as claimed in claim 1, in which there is a substantially linear relationship between relative rotation of the closure arrangement and die alteration in fluid flow.

11. A spray jet assembly including an inlet for connection to a fluid supply, a nozzle arrangement allowing for the expulsion of fluid in a spray pattern, and which includes a fluid flow controlling mechanism as claimed in claim 1.

12. A spray jet assembly, as claimed in claim 11, which is intended for use in a shower or cleansing cabinet, in a wet area or enclosure, tiled area, or the like, and in which water is expulsed from the assembly in substantially an axial direction.

13. A spray jet assembly, as claimed in claim 11, in which the closure arrangement of the fluid flow controlling mechanism more rapidly cuts off water flow past a certain lower threshold point to prevent dribbling from the nozzle arrangement at low flow rates.
